(19) United States
(12) Patent Application Publication
(10) Pub. No.: US 2016/0034009 A1
(43) Pub. Date: Feb. 4, 2016

(54) THERMAL PROTECTION METHOD FOR REFERRING TO THERMAL HEADROOM TO CONTROL SELECTION OF COMPUTING POWER SETTING OF PROCESSOR-BASED SYSTEM AND RELATED MACHINE READABLE MEDIUM

(71) Applicant: Mediatek Inc., Hsin-Chu (TW)

(72) Inventors: Wei-Ting Wang, Taipei City (TW); Chien-Tse Fang, Taipei City (TW); Chia-Feng Yeh, New Taipei City (TW)

(21) Appl. No.: 14/700,111

(22) Filed: Apr. 29, 2015

Related U.S. Application Data
(60) Provisional application No. 62/031,966, filed on Aug. 1, 2014.

(51) Int. Cl. G06F 1/20

(52) U.S. Cl. CPC G06F 1/206

(57) ABSTRACT

A thermal protection method includes: determining a thermal headroom based on a difference between a current temperature and a predetermined threshold temperature; determining a power budget based on the thermal headroom; and utilizing a processor-based system to employ a target computing power setting according to at least the power budget, wherein selection of the target computing power setting is constrained by the power budget to ensure that the target computing power setting does not make the current temperature exceed the predetermined threshold temperature when employed by the processor-based system.

### CROSS REFERENCE TO RELATED APPLICATIONS

This application claims the benefit of U.S. provisional application No. 62/031,966, filed on Aug. 1, 2014 and incorporated herein by reference.

### BACKGROUND

The present invention relates to thermal protection, and more particularly, to a thermal protection method for referring to a thermal headroom to control selection of a computing power setting of a processor-based system and a related machine readable medium.

The system-on-chip (SoC) of a mobile device requires higher performance than ever, and therefore supports higher computing power. When the SoC is operated under a high computing power mode, heat dissipation becomes an important issue because the mobile device form-factor is small. A die junction temperature of the SoC may have a significant jump due to a large power change of the SoC. If the die junction temperature of the SoC exceeds a threshold temperature (i.e., a maximum permitted die junction temperature), the SoC may have a shorter lifespan due to permanent damage caused by the undesired temperature overshoot.

Thus, there is a need for an innovative thermal protection scheme which is capable of preventing a current temperature (e.g., a current die junction temperature) from exceeding a predetermined threshold temperature.

### SUMMARY

One of the objectives of the claimed invention is to provide a thermal protection method for referring to a thermal headroom to control selection of a computing power setting of a processor-based system and a related machine readable medium.

According to a first aspect of the present invention, an exemplary thermal protection method is disclosed. The exemplary thermal protection method includes: determining a thermal headroom based on a difference between a current temperature and a predetermined threshold temperature; determining a power budget based on the thermal headroom; and utilizing a processor-based system to employ a target computing power setting according to at least the power budget, wherein selection of the target computing power setting is constrained by the power budget to ensure that the target computing power setting does not make the current temperature exceed the predetermined threshold temperature when employed by the processor-based system.

According to a second aspect of the present invention, an exemplary machine readable medium having a program code stored therein is disclosed. When executed by a processor-based system, the program code instructs the processor-based system to perform following steps: determining a thermal headroom based on a difference between a current temperature and a predetermined threshold temperature; determining a power budget based on the thermal headroom; and employing a target computing power setting according to at least the power budget, wherein selection of the target computing power setting is constrained by the power budget to ensure that the target computing power setting does not make the current temperature exceed the predetermined threshold temperature when employed by the processor-based system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an electronic device according to an embodiment of the present invention.

FIG. 2 is a flowchart illustrating a thermal protection method according to an embodiment of the present invention.

FIG. 3 is a diagram illustrating a time-variant thermal headroom according to an embodiment of the present invention.

FIG. 4 is a diagram illustrating a relationship between a current temperature measured by a measurement circuit and a power budget determined by a program code executed by a processor-based system according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

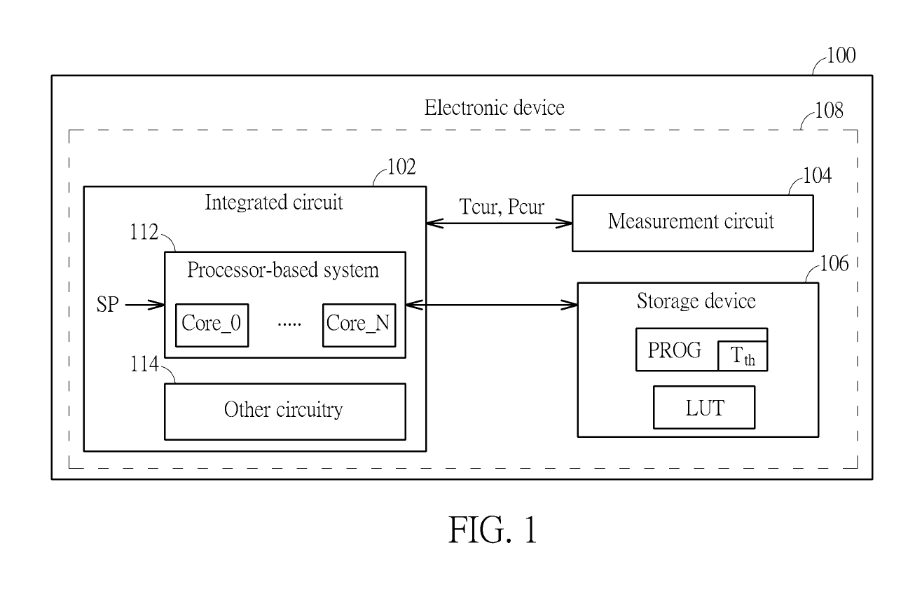

FIG. 1 is a block diagram illustrating an electronic device according to an embodiment of the present invention. By way of example, but not limitation, the electronic device 100 may be a mobile device such as a mobile phone, a tablet or a wearable device. As shown in FIG. 1, the electronic device 100 includes an integrated circuit (e.g., SoC) 102, a measurement circuit 104 and a storage device 106 installed on a circuit board (e.g., a printed circuit board) 108. The integrated circuit 102 may have a processor-based system 112. The processor-based system 112 may include one or more processor cores Core 0-Core N, depending upon actual design consideration. For example, the processor-based system 112 may be a single-core processor or a multi-core processor. In addition, the integrated circuit 102 may further include other circuitry 114 for achieving other functions. The measurement circuit 104 may be configured to support temperature measurement and/or power measurement. Hence, the measurement circuit 104 is capable of determining a current temperature T_{cur} (° C.) and/or a current power P_{cur} (mW) that may be used by the proposed thermal protection scheme. The storage device 106 is a machine readable medium, such as a non-volatile memory or a volatile memory. In this embodiment, the storage device 106 has a program code PROG and a power lookup table LUT stored therein. For example, the program code PROG may be part of firmware or operating system (OS) of the electronic device 100. When loaded and executed by the processor-based system 112, the program code PROG instructs the processor-based system 112 to perform the proposed thermal protection scheme to control selection of computing power setting (i.e., performance setting) SP employed by the processor-based system 112. In one exemplary design, the thermal protection scheme may employ a table lookup manner to control selection of computing power setting SP. Hence, the power lookup table LUT may be referenced by the thermal protection scheme. However, the power lookup table LUT may be optional. For example, in an alternative design, the thermal protection scheme may employ a direct computation manner (e.g., a predetermined formula) to control selection of computing power setting SP. Since there is no need to use the power lookup table LUT, the power lookup table LUT can be omitted. Further details of the proposed thermal protection scheme are described as below.

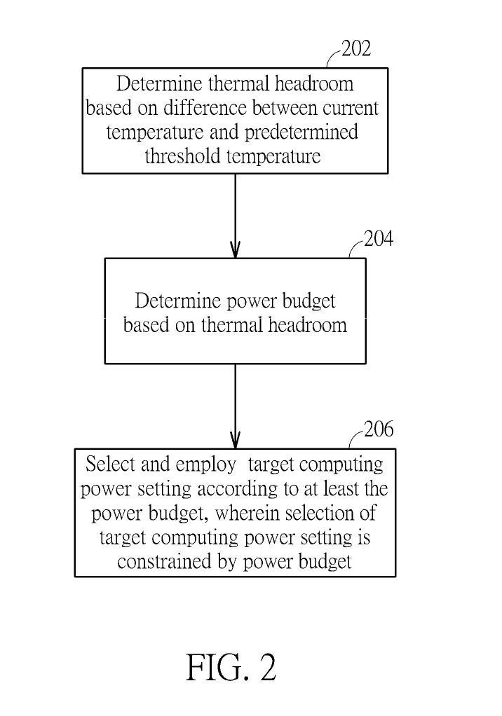

FIG. 2 is a flowchart illustrating a thermal protection method according to an embodiment of the present invention. The thermal protection method may be performed and controlled by the program code PROG running on the processor-based system 112. Provided that the result is substantially the same, the steps are not required to be executed in the exact order shown in FIG. 2. The thermal protection method may be briefly summarized as below.

Step 202: Determine a thermal headroom max_deltaT (° C.) based on a difference between a current temperature T_{cur} and a predetermined threshold temperature Tₜₕ.

Step 204: Determine a power budget THP_max_power based on the thermal headroom max_deltaT.

Step 206: Select and employ a target computing power setting SP according to at least the power budget THP_max_power, wherein selection of the target computing power setting is constrained by the power budget THP_max_power to ensure that the target computing power setting does not make the current temperature T_{cur} exceed the predetermined threshold temperature Tₜₕ when employed by the processor-based system 112.

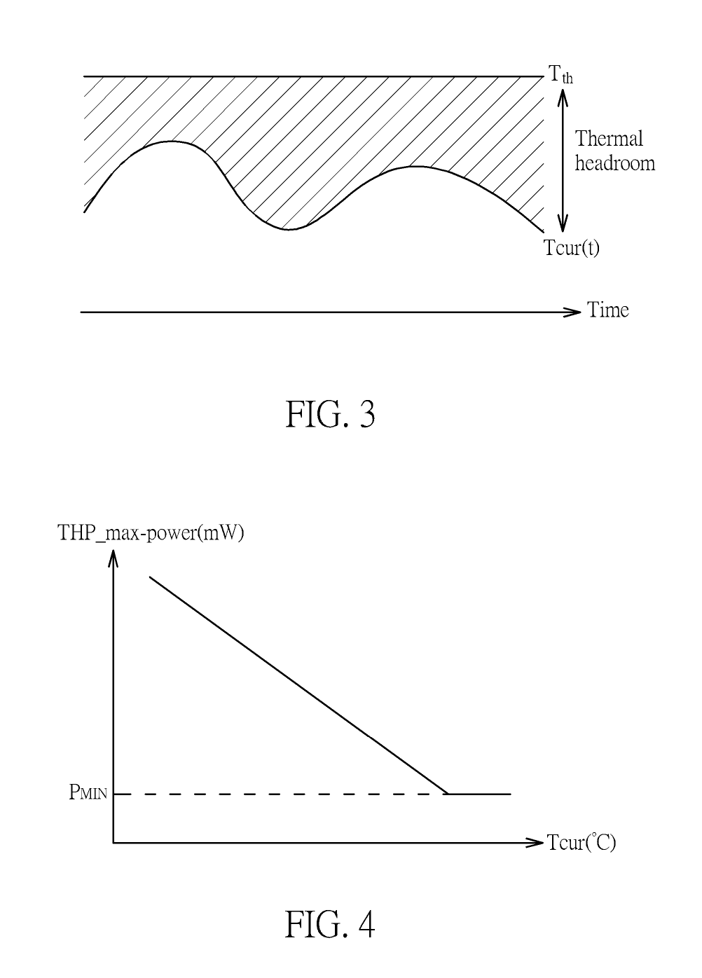

In step 202, the program code PROG running on the processor-based system 112 calculates the thermal headroom max_deltaT based on the difference between the current temperature T_{cur} measured by the measurement circuit 104 at the current time instance and the predetermined threshold temperature Tₜₕ. That is, max_deltaT=Tₜₕ−T_{cUr}. FIG. 3 is a diagram illustrating a time-variant thermal headroom according to an embodiment of the present invention. The predetermined threshold temperature Tₜₕ may be set based on hardware and system requirement, and is a time-invariant parameter during the thermal protection process. The current temperature T_{cur} is a time-variant parameter that may be measured by the measurement circuit 104 at different time instances during the thermal protection process. For each time instance, the difference between the current temperature T_{cur} and the predetermined threshold temperature Tₜₕ is regarded as temperature headroom (marked by oblique lines in FIG. 3), where the predetermined threshold temperature Tₜₕ defines a maximum permitted temperature.

In step 204, the program code PROG running on the processor-based system 112 converts the calculated thermal headroom max_deltaT into a power budget THP_max_power. In one exemplary design, the program code PROG running on the processor-based system 112 multiplies the thermal headroom max_deltaT by a predetermined correlation parameter P_T to determine an increment power max_deltaP (mW). That is, max_deltaP=max_deltaT*P_T. The predetermined correlation parameter P_T may be set based on hardware and system requirement.

Next, the program code PROG running on the processor-based system 112 determines the power budget THP_max_power (mW) based on at least the increment power max_deltaP. In one exemplary design, the current power P_{cur} of the processor-based system 112 is further considered to determine the power budget THP_max_power. For example, THP_max_power=max_deltaP+P_{cur}. In another exemplary design, the power budget THP_max_power is set by the increment power max_deltaP, regardless of the current power P_{cur}. For example, THP_max_power=max_deltaP. Since estimation/computation of the current power P_{cur} (i.e., real power consumption at the current time instance) of the processor-based system 112 may be complicated, a simplified algorithm which simply sets the power budget THP_max_power by the increment power max_deltaP may be used. Specifically, it is assumed that P_{cur}=0 and the processor-based system 112 is currently in an idle state. Though the power budget THP_max_power set by the increment power max_deltaP is less accurate than the power budget THP_max_power set by the increment power max_deltaP plus the current power P_{cur}, the computation complexity can be effectively reduced due to the fact that there is no need to compute/estimate the current power P_{cur} (i.e., real power consumption at the current time instance) during the thermal protection process.

FIG. 4 is a diagram illustrating a relationship between a current temperature T_{cur} measured by the measurement circuit 104 and a power budget THP_max_power determined by the program code PROG running on the processor-based system 112 according to an embodiment of the present invention. In this example, there is a negative correlation between the current temperature T_{cur} and the power budget THP_max_power. That is, when the current temperature T_{cur} increases over time, the power budget THP_max_power decreases correspondingly; and when the current temperature T_{cur} decreases over time, the power budget THP_max_power increases correspondingly. As will be detailed later, the power budget THP_max_power controls selection of the computing power setting (i.e., performance setting) employed by the processor-based system 112, and a smaller power budget THP_max_power will enforce the processor-based system 112 to operate with lower computing power. To prevent user experience from being significantly degraded due to the proposed thermal protection scheme, a clamping function may be used to pervert the power budget THP_max_power from being smaller than a predetermined lower bound P_{MIN}. Specifically, when the power budget THP_max_power calculated based on THP_max_power=max_deltaP+P_{cur} or THP_max_power=max_deltaP is found smaller than the predetermined lower bound P_{MIN}, the program code PROG running on the processor-based system 112 further clamps the power budget THP_max_power at the predetermined lower bound P_{MIN} (i.e., THP_max_power=P_{MIN}).

In step 206, the program code PROG running on the processor-based system 112 selects and employs the target computing power setting SP according to at least the power budget THP_max_power. Consider a case where the thermal protection scheme employs a table lookup manner to control selection of the target computing power setting SP. Hence, the power lookup table LUT is stored in the storage device 106. The power lookup table LUT is configured to record a plurality of power values mapped to a plurality of computing power settings of the processor-based system 112, respectively. That is, each of the computing power settings recorded in the power lookup table LUT may be regarded as a candidate computing power setting that may be selected and used by the processor-based system 112. An example of the power lookup table LUT is illustrated as below.

| | Performance Index | Power Value |
|---|---|---|
| Computing | (DMIPS, GHz, or other performance | (mW or |
| Power Setting | metric) | other power unit) |
| SP_0 | 30000 | 8000 |
| SP_1 | 25000 | 7000 |
| SP_2 | 20000 | 6000 |
| SP_3 | 15000 | 5000 |
| SP_4 | 10000 | 4000 |
| SP_5 | 5000 | 3000 |

When the computing power setting SP_{—}0 is selected as the target computing power setting SP (i.e., SP=SP_{—}0), the processor-based system 112 has the maximum power consumption and the highest processor performance. However, when the computing power setting SP_{—}5 is selected as the target computing power setting SP (i.e., SP=SP_{—}5), the processor-based system 112 has the minimum power consumption and the lowest processor performance. Specifically, the computing power settings SP_{—}0-SP_{—}5 are associated with different power values. For example, the processor-based system 112 employing one of the computing power settings SP_{—}0-SP_{—}5 and the processor-based system 112 employing another of the computing power settings SP_{—}0-SP_{—}5 may have different DVFS (dynamic voltage and frequency scaling) settings, different numbers of enabled processor cores (i.e., different hotplug settings), different bandwidth/throughput adjustments, and/or other different performance-related hardware configurations. It should be note that the performance indices and power values shown in above power lookup table are for illustrative purposes only, and are not meant to be limitations of the present invention.

The power lookup table LUT may be built under a boundary (worst) case and then stored into the storage device 106 for later use. Hence, the computing power settings SP_{—}0-SP_{—}5 are tested under the boundary (worst) case to evaluate power values and associated performance indices, and the power lookup table LUT is built based on the computing power settings SP_{—}0-SP_{—}5, the evaluated power values, and the evaluated performance indices. For example, the power lookup table LUT may be predetermined and generated by using a maximum permitted supply voltage and a relatively high temperature (e.g., 100° C.) as the boundary (worst) case. Alternatively, the power lookup table LUT may be generated according to a current supply voltage and a current temperature and then stored into the storage device 106.

After the power budget THP_max_power is calculated in response to the current temperature T_{cur} measured at the current time instance, the program code PROG running on the processor-based system 112 compares the power budget THP_max_power with the power values recorded in the power lookup table LUT to identify invalid computing power setting(s) under the power budget THP_max_power. Specifically, when a power value recorded in the power lookup table LUT is larger than the power budget THP_max_power, the program code PROG running on the processor-based system 112 blocks the corresponding computing power setting recorded in the power lookup table LUT from being selected as the target computing power setting SP. In other words, when a candidate computing power setting is mapped to a power value exceeding the power budget THP_max_power, the candidate computing power setting would be disabled. Taking the exemplary power lookup table LUT illustrated above for example, the computing power settings SP_{—}0-SP_{—}1 are both disabled if THP_max_power=6500 mW, the computing power settings SP_{—}0-SP_{—}4 are disabled if THP_max_power=3500 mW, and none of the computing power settings SP_{—}0-SP_{—}5 is disabled if THP_max_power>8000 mW. It should be noted that the predetermined lower bound P_{MIN} used for clamping the calculated power budget THP_max_power may be set by the minimum power value recorded in the power lookup table LUT.

After classifying the computing power settings recorded in the power lookup table LUT based on the power budget THP_max_power, the program code PROG running on the processor-based system 112 selects one of computing power settings in the power lookup table LUT (particularly, one of non-disabled computing power setting(s) in the recorded in the power lookup table LUT) as the target computing power setting SP. For example, the program code PROG running on the processor-based system 112 may compare a performance requirement and the performance indices associated with non-disabled computing power settings to find an optimum non-disabled computing power setting as the target computing power setting SP. However, this is for illustrative purposes only, and is not meant to be a limitation of the present invention.

As mentioned above, the current power P_{cur} may be considered to determine the power budget THP_max_power. In one exemplary design, the current power P_{cur} may be measured by hardware (e.g., measurement circuit 104). In another exemplary design, the current power P_{cur} may be estimated using a power value that is recorded in the power lookup table LUT and is mapped to a current computing power setting (i.e., a current performance setting) employed by the processor-based system 112. Taking the exemplary power lookup table LUT illustrated above for example, the current power P_{cur} is estimated to be 5000 mW when the computing power setting currently employed by the processor-based system 112 is SP_{—}3. After the power budget THP_max_power is determined by adding the estimated current power P_{cur} (P_{cur}=5000 mW) to the increment power max_deltaP, the computing power setting currently employed by the processor-based system 112 may be updated by a newly selected computing power setting.

The proposed thermal protection scheme may be applied to a variety of applications. For example, the aforementioned current temperature T_{cur} may be a die junction temperature of the integrated circuit 102 (particularly, a die junction temperature of the processor-based system 112), a board temperature of the circuit board 108, or a surface touch temperature of the electronic device 100 (i.e., a skin temperature of user's hand holding the electronic device 100). However, these are for illustrative purposes only, and are not meant to be limitations of the present invention. Any electronic device or SoC design using the proposed thermal protection scheme falls within the scope of the present invention.

In conclusion, the proposed thermal protection scheme is capable of ensuring that a computing power setting does not make a current temperature (e.g., a current die junction temperature) exceed a predetermined threshold temperature when employed by a processor-based system. In other words, the proposed thermal protection scheme is capable of keeping the current temperature (e.g., current die junction temperature) below the predetermined threshold temperature. The abnormal power change can be avoided, which is beneficial for system stability and performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A thermal protection method comprising:
determining a thermal headroom based on a difference between a current temperature and a predetermined threshold temperature;
determining a power budget based on the thermal headroom; and
utilizing a processor-based system to employ a target computing power setting according to at least the power budget, wherein selection of the target computing power setting is constrained by the power budget to ensure that the target computing power setting does not make the current temperature exceed the predetermined threshold temperature when employed by the processor-based system.

2. The thermal protection method of claim 1, wherein the processor-based system is part of an integrated circuit, and the current temperature is a die junction temperature of the integrated circuit.

3. The thermal protection method of claim 1, wherein the processor-based system is installed on a circuit board, and the current temperature is a board temperature of the circuit board.

4. The thermal protection method of claim 1, wherein the processor-based system is part of an electronic device, and the current temperature is a surface touch temperature of the electronic device.

5. The thermal protection method of claim 1, wherein determining the power budget based on the thermal headroom comprises:
multiplying the thermal headroom by a predetermined correlation parameter to determine an increment power; and
determining the power budget based on at least the increment power.

6. The thermal protection method of claim 5, wherein determining the power budget based on at least the increment power comprises:
setting the power budget by the increment power, regardless of a current power of the processor-based system.

7. The thermal protection method of claim 6, wherein determining the power budget based on at least the increment power further comprises:
when the power budget is smaller than a predetermined lower bound, clamping the power budget at the predetermined lower bound.

8. The thermal protection method of claim 5, wherein determining the power budget based on at least the increment power comprises:
determining a current power of the processor-based system; and
setting the power budget by adding the increment power to the current power.

9. The thermal protection method of claim 8, wherein determining the power budget based on at least the increment power further comprises:
when the power budget is smaller than a predetermined lower bound, clamping the power budget at the predetermined lower bound.

10. The thermal protection method of claim 8, wherein determining the current power comprises:
estimating the current power by using a power value that is recorded in a power lookup table and is mapped to a current computing power setting employed by the processor-based system, wherein the power lookup table records a plurality of power values mapped to a plurality of computing power settings of the processor-based system, respectively.

11. The thermal protection method of claim 1, wherein utilizing the processor-based system to employ the target computing power setting according to at least the power budget comprises:
comparing the power budget with a plurality of power values recorded in a power lookup table, wherein the power lookup table records the power values mapped to a plurality of computing power settings of the processor-based system, respectively;
when a power value recorded in the power lookup table is larger than the power budget, blocking a corresponding computing power setting recorded in the power lookup table from being selected as the target computing power setting; and
selecting one of the computing power settings recorded in the power lookup table as the target computing power setting.

12. A machine readable medium having a program code stored therein, wherein when executed by a processor-based system, the program code instructs the processor-based system to perform following steps:
determining a thermal headroom based on a difference between a current temperature and a predetermined threshold temperature;
determining a power budget based on the thermal headroom; and
employing a target computing power setting according to at least the power budget, wherein selection of the target computing power setting is constrained by the power budget to ensure that the target computing power setting does not make the current temperature exceed the predetermined threshold temperature when employed by the processor-based system.

13. The machine readable medium of claim 12, wherein the current temperature is a die junction temperature of an integrated circuit having the processor-based system included therein.

14. The machine readable medium of claim 12, wherein the current temperature is a board temperature of a circuit board on which the processor-based system is installed.

15. The machine readable medium of claim 12, wherein the current temperature is a surface touch temperature of an electronic device having the processor-based system included therein.

16. The machine readable medium of claim 12, wherein determining the power budget based on the thermal headroom comprises:
multiplying the thermal headroom by a predetermined correlation parameter to determine an increment power; and
determining the power budget based on at least the increment power.

17. The machine readable medium of claim 16, wherein determining the power budget based on at least the increment power comprises:
setting the power budget by the increment power, regardless of a current power of the processor-based system.

18. The machine readable medium of claim 17, wherein determining the power budget based on at least the increment power further comprises:
when the power budget is smaller than a predetermined lower bound, clamping the power budget at the predetermined lower bound.

19. The machine readable medium of claim 16, wherein determining the power budget based on at least the increment power comprises:
determining a current power of the processor-based system; and
setting the power budget by adding the increment power to the current power.

20. The machine readable medium of claim 19, wherein determining the power budget based on at least the increment power further comprises:
when the power budget is smaller than a predetermined lower bound, clamping the power budget at the predetermined lower bound.

21. The machine readable medium of claim 19, wherein determining the current power comprises:
estimating the current power by using a power value that is recorded in a power lookup table and is mapped to a current computing power setting employed by the processor-based system, wherein the power lookup table records a plurality of power values mapped to a plurality of computing power settings of the processor-based system, respectively.

22. The machine readable medium of claim 12, wherein employing the target computing power setting according to at least the power budget comprises:
comparing the power budget with a plurality of power values recorded in a power lookup table, wherein the power lookup table records the power values mapped to a plurality of computing power settings of the processor-based system, respectively;
when a power value recorded in the power lookup table is larger than the power budget, blocking a corresponding computing power setting recorded in the power lookup table from being selected as the target computing power setting; and
selecting one of the computing power settings recorded in the power lookup table as the target computing power setting.
